(19) United States
(12) Patent Application Publication
(10) Pub. No.: US 2025/0384114 A1
(43) Pub. Date: Dec. 18, 2025

(54) AUTHENTICATION APPARATUS

(71) Applicant: NTT DOCOMO, INC., Tokyo (JP)

(72) Inventors: Sadaatsu KATO, Chiyoda-ku (JP); Masayoshi SASAKI, Chiyoda-ku (JP); Youhei FUJIMOTO, Chiyoda-ku (JP); Keiichi MURAKAMI, Chiyoda-ku (JP); Ichitaro TSUKADA, Chiyoda-ku (JP); Kouhei OOYAMA, Chiyoda-ku (JP); Syun HAMACHI, Chiyoda-ku (JP); Momoko ABE, Chiyoda-ku (JP); Tomohito YAMASAKI, Chiyoda-ku (JP)

(73) Assignee: NTT DOCOMO, INC., Tokyo (JP)

(21) Appl. No.: 18/878,778

(22) PCT Filed: May 10, 2023
(86) PCT No.: PCT/JP2023/017588

§ 371 Date: Dec. 24, 2024

(30) Foreign Application Priority Data
Jul. 5, 2022 (JP) 2022-108383

(51) Int. Cl. G06F 21/32; G06T 13/40; G06V 40/16

(52) U.S. Cl. CPC G06F 21/32; G06T 13/40; G06V 40/172

(57) ABSTRACT

An authentication apparatus includes an avatar generator configured to generate avatar data representative of an avatar of a service user who uses a service relating to avatars, the avatar data being generated using a user image obtained by capturing an image of the service user; an authenticator configured to generate authentication data in a case in which the avatar data is verified as being authentic; and an authentication data remover configured to remove the authentication data based on a removal condition being satisfied.

### TECHNICAL FIELD

The present invention relates to authentication apparatuses.

### BACKGROUND ART

In a virtual space using XR (Cross Reality) techniques including VR (Virtual Reality) techniques, AR (Augmented Reality) techniques, and MR (Mixed Reality) techniques, there may be provided services of “3D avatars” in which a user is represented using three-dimensional images. Such 3D avatars include an avatar created using a facial photograph of the user. Avatars include both “real avatars” that closely resemble a user and avatars that are animated to capture the characteristics of a user.

For example, Patent Document 1 discloses a method for creating and editing an avatar, in which photograph data of a user's face transmitted through a network is received from a terminal apparatus used by the user, and parts of a face portion of the avatar is created using the photograph data.

### RELATED ART DOCUMENT

### Patent Document

Patent Document 1

Japanese Patent Application Laid-Open Publication 2009-223419

### SUMMARY OF THE INVENTION

### Problem to be Solved by the Invention

However, in conventional techniques, it is possible for a malicious user to create a real avatar or an animated avatar of someone else by using a photograph of a face of that person without permission.

For example, there is a risk that a celebrity's reputation may be damaged due to an avatar with the same appearance as that of the celebrity making inappropriate speech or action, the avatar being created by a third person. In addition, since the appearance of the avatar closely resembles a celebrity, ordinary users may be deceived by the words, actions, and behavior of the avatar closely resembling the celebrity, and may suffer disadvantages.

In view of such risk, a technique is required for determining whether an avatar having an appearance that closely resembles a person is created by that person.

Accordingly, an object of the present invention is to provide an authentication apparatus for adding to or removing authentication from an avatar that closely resembles an individual in appearance, with the authentication indicating that the avatar was created by that individual.

### Means of Solving the Problems

An authentication apparatus according to a preferred embodiment of the present invention is an authentication apparatus of avatar data, and includes: an avatar generator configured to generate avatar data representative of an avatar of a service user who uses a service relating to avatars, the avatar data being generated using a user image obtained by capturing an image of the service user; an authenticator configured to generate authentication data in a case in which the avatar data is verified as being authentic; and an authentication data remover configured to remove the authentication data based on a removal condition being satisfied.

### Effects of the Invention

According to the present invention, it is possible to add and remove authentication for information that an avatar with an appearance that closely resembles a certain person was created by that person.

### BRIEF DESCRIPTION OF THE DRAWINGS

FIG. 1 is a diagram illustrating an overall configuration of an avatar system 1.

FIG. 2 is a diagram illustrating an example avatar AK.

FIG. 3 is a block diagram illustrating an example configuration of a terminal apparatus 30-K.

FIG. 4 is a block diagram illustrating an example configuration of an authentication apparatus 10.

FIG. 5 is a flowchart illustrating an example operation performed when the authentication apparatus 10 generates avatar data AD.

FIG. 6 is a flowchart illustrating an example operation performed when the authentication apparatus 10 removes authentication data.

FIG. 7 is a block diagram illustrating an example configuration of an authentication apparatus 10A.

FIG. 8 is a functional block diagram illustrating a configuration of a request acceptor 118A.

FIG. 9 is a functional block diagram illustrating a configuration of a request determiner 120.

FIG. 10 is a flowchart illustrating an example operation performed when the authentication apparatus 10A forcibly removes authentication data.

FIG. 11 is a flowchart illustrating an example operation performed when the authentication apparatus 10A forcibly generates authentication data.

FIG. 12 is a functional block diagram illustrating a configuration of a request determiner 120B.

FIG. 13 is a flowchart illustrating an example operation performed when the authentication apparatus 10B forcibly removes authentication data.

### MODES FOR CARRYING OUT THE INVENTION

### 1: First Embodiment

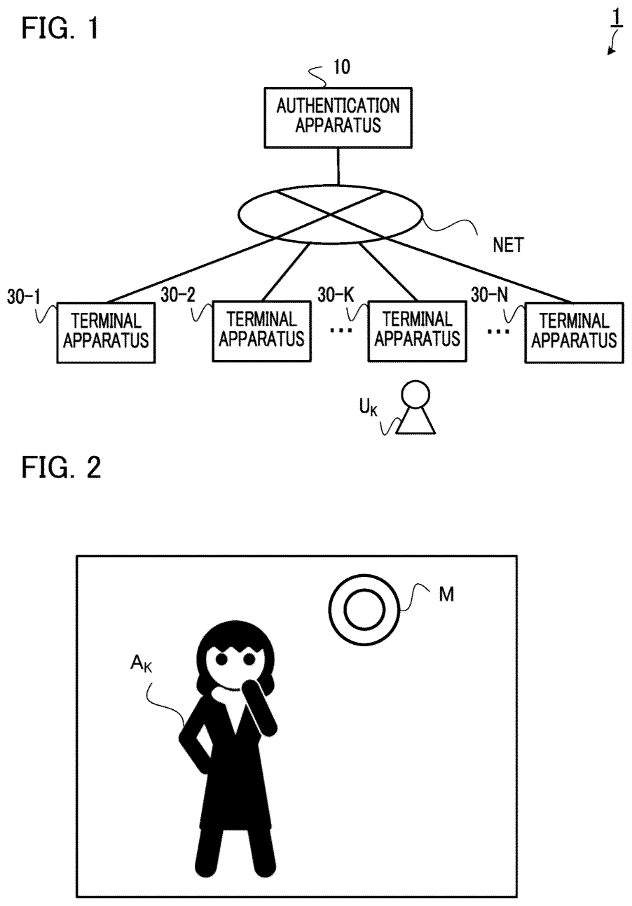

In the following, a description will be given of an avatar system 1 with reference to FIGS. 1 to 6, the avatar system 1 including an authentication apparatus 10 according to a first embodiment of the present invention.

The authentication apparatus 10 according to the present embodiment first generates avatar data representing an avatar that is not authenticated by a person themselves, and later adds authentication indicating authenticity to the avatar data.

### 1-1: Configuration of First Embodiment

### 1-1-1: Overall Configuration

FIG. 1 shows an overall configuration of the avatar system 1 according to the first embodiment. As illustrated in FIG. 1, the avatar system 1 includes the authentication apparatus 10, terminal apparatuses 30-1, 30-2, . . . 30-K, . . . 30-N. N is an integer of 2 or more. K is an integer of 1 or more and N or less. In the present embodiment, the terminal apparatuses 30-1 to 30-N have the same configuration. However, a terminal apparatus having a different configuration may be included. In the following description, the terminal apparatuses 30-1 to 30-N may be generally referred to as a “terminal apparatus 30” or “terminal apparatuses 30”. The authentication apparatus 10 and the terminal apparatuses 30-1 to 30-N may be, for example, smartphones or tablets, or may be a PC (Personal Computer).

In the avatar system 1, the authentication apparatus 10 and the terminal apparatuses 30-1 to 30-N are communicably connected to each other via a communication network NET. In FIG. 1, the user UK uses the terminal apparatus 30-K. In the following description, a user who uses one of the terminal apparatuses 30-1 to 30-N may be generally referred to as a “user U” or “users U”.

The authentication apparatus 10 is used by a user U to generate an avatar. The authentication apparatus 10 is a device that performs addition to and removal of authentication from avatar data representing the generated avatar. The “authentication” verifies that avatar data has been generated by the user U and that it is authentic avatar data.

For example, when the user UK uses the authentication apparatus 10 to generate an avatar, the authentication apparatus 10 generates avatar data representing an avatar that closely resembles the user UK in appearance. Based on generation of the avatar by the user UK, the authentication apparatus 10 verifies that the avatar data representing the avatar is authentic data that was generated by the user UK, and generates authentication data to be added to the avatar data. Furthermore, when a predetermined removal condition is satisfied, the authentication apparatus 10 removes the authentication data from the avatar data.

FIG. 2 shows an example avatar AK generated using the authentication apparatus 10 by the user UK themselves. In this example, avatar data representing the avatar AK has been verified as being authentic. As illustrated in FIG. 2, an authentication mark M indicating that the avatar data representing the avatar AK has been authenticated is added to the avatar AK. In FIG. 2, the avatar AK is illustrated in a simplified manner.

The terminal apparatus 30 is a device that displays an avatar A. Specifically, the terminal apparatus 30 includes a display 34, described later. The avatar A is displayed on the display 34. It is to be noted that an avatar AK corresponding to the real user UK and generated by that real user UK is not limited to being displayed on the terminal apparatus 30-K, but may also be displayed on another terminal apparatus 30, such that a user U other than the user UK can visually recognize the avatar AK on a display 34 provided in the other terminal apparatus 30. Furthermore, XR glasses, XR goggles, or an HMD (Head Mounted Display) using XR techniques may be connected to the terminal apparatus 30.

### 1-1-2. Configuration of Terminal Apparatus

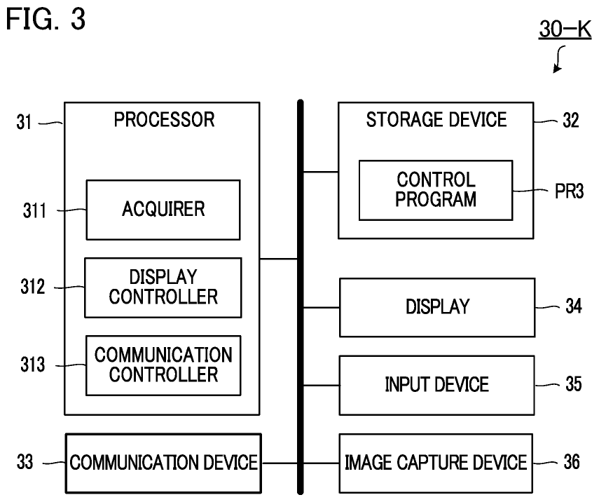

FIG. 3 is a block diagram illustrating an example configuration of a terminal apparatus 30-K. The terminal apparatus 30-K includes a processor 31, a storage device 32, a communication device 33, a display 34, an input device 35. and an image capture device 36. Each element of the terminal apparatus 30 is connected to the others by a single bus or multiple buses for communicating information.

The processor 31 controls the entire terminal apparatus 30-K. The processor 31 is configured using, for example, a single chip or multiple chips. The processor 31 is configured using, for example, a central processing unit (CPU) including interfaces with peripheral devices, an arithmetic unit, a register, and a similar device. It is to be noted that some or all the functions of the processor 31 may be realized by hardware such as DSP, ASIC, PLD, and FPGA. The processor 31 executes various processes in parallel or sequentially.

The storage device 32 is a recording medium that can be read and written by the processor 31. The storage device 32 stores a plurality of programs including a control program PR3 executed by the processor 31. In addition, the storage device 32 stores account information used by the user UK to log in to the avatar system 1. The account information includes, for example, one or more of a user UK account ID, a user UK telephone number, a user UK mail address, biometric information such as a fingerprint of the user UK, a password set by the user UK themselves, an authentication pattern, a photograph on a driver's license of the user UK, and a facial photograph database of the user UK. In addition, the account information is transmitted from the terminal apparatus 30-K to the authentication apparatus 10 and is stored in a storage device 12 provided in the authentication apparatus 10. For example, when the user UK Jogs in to the avatar system 1, the account information stored in the terminal apparatus 30-K is compared with the account information stored in the authentication apparatus 10.

The communication device 33 is hardware in the form of a transmitter-receiver device (transceiver device) for communicating with other devices. The communication device 33 is also referred to as, for example, a network device, a network controller, a network card, a communication module, or a similar device. The communication device 33 may include a connector for wired connection, and may include an interface circuit corresponding to the connector. The communication device 33 may include a wireless communication interface. Connectors and interface circuitry for wired connection include those compliant with wired LAN, IEEE1394, USB. Examples of the wireless communication interfaces include wireless LAN and those compliant with Bluetooth (registered trademark) or a similar interface.

The display 34 is a device that displays images and text information. The display 34 displays various images under the control of the processor 31. For example, various display panels such as a liquid crystal display panel and an organic EL (Electroluminescent) display panel are suitably used as the display 34. It is to be noted that, as described above, when XR glasses, XR goggles, or an HMD using XR techniques is connected to the terminal apparatus 30-K, these XR glasses, XR goggles, or HMD using XR techniques may be used in place of the display 34.

The input device 35 receives a user operation from the user UK. For example, the input device 35 includes a keyboard, a touchpad, a touch panel, or a pointing device such as a mouse. The input device 35 with a touch panel may also serve as the display 34.

In generating an avatar AK, the user UK uploads a user image used for generating the avatar AK to the authentication apparatus 10. In uploading the user image, the input device 35 is used by the user UK to input the user image into the terminal apparatus 30. It is preferable that the user image is, for example, a photograph of the face of the user UK or a photograph of the entirety of the user UK.

The image capture device 36 outputs captured image information obtained by capturing an image of a real world. The image capture device 36 includes, for example, a lens, an imaging element, an amplifier, and an AD converter. Light focused through the lens is converted by the imaging element into a captured image signal, which is an analog signal. The amplifier amplifies the captured image signal and outputs it to the AD converter. The AD converter converts the amplified captured image signal, which is an analog signal, into captured image information, which is a digital signal. The converted captured image information is supplied to the processor 31. The captured image information supplied to the processor 31 is output to the authentication apparatus 10 via the communication device 33.

When an avatar AK is to be generated, the authentication apparatus 10 needs to verify the authenticity of a user UK. For verification of authenticity, the image capture device 36 captures an image of the user UK. For verification of authenticity, the head of the user UK is preferably captured by the image capture device 36. Captured image information representing the image captured by the image capture device 36 is supplied to the processor 31. The captured image information output to the processor 31 is transmitted from the terminal apparatus 30-K to the authentication apparatus 10 as information representing a first verification image. The first verification image is an image used for verifying that the user UK is a service user using the service.

When authentication data is to be removed, the authentication apparatus 10 needs to verify the identity of a user UK. For verification of identity, the image capture device 36 captures an image of the user UK. For verification of identity, it is preferable that an image of the head of the user UK is captured by the image capture device 36. The captured image information representing an image captured by the image capture device 36 is supplied to the processor 31. The captured image information output to the processor 31 is output to the authentication apparatus 10 as information representing a second verification image that is an image used for identity verification. In the present embodiment, the second verification image is an example of a “verification image”.

The processor 31 reads and executes the control program PR3 from the storage device 32, thereby functioning as an acquirer 311, a display controller 312, and a communication controller 313.

The acquirer 311 acquires information representing a user image from the input device 35. Furthermore, the acquirer 311 acquires information representing a first verification image and information representing a second verification image from the image capture device 36.

In a case in which avatar data representing an avatar AK corresponding to a user UK is generated by the authentication apparatus 10, the acquirer 311 acquires the avatar data from the authentication apparatus 10 via the communication device 33.

The display controller 312 causes the display 34 to display an avatar AK using avatar data acquired by the acquirer 311.

The communication controller 313 causes the communication device 33 to transmit to the authentication apparatus 10 information representing a user image, information representing a first verification image, and information representing a second verification image, all acquired by the acquirer 311. The communication controller 313 also causes a removal request requesting removal of authentication to be transmitted to the authentication apparatus 10).

### 1-1-3: Configuration of Authentication Apparatus

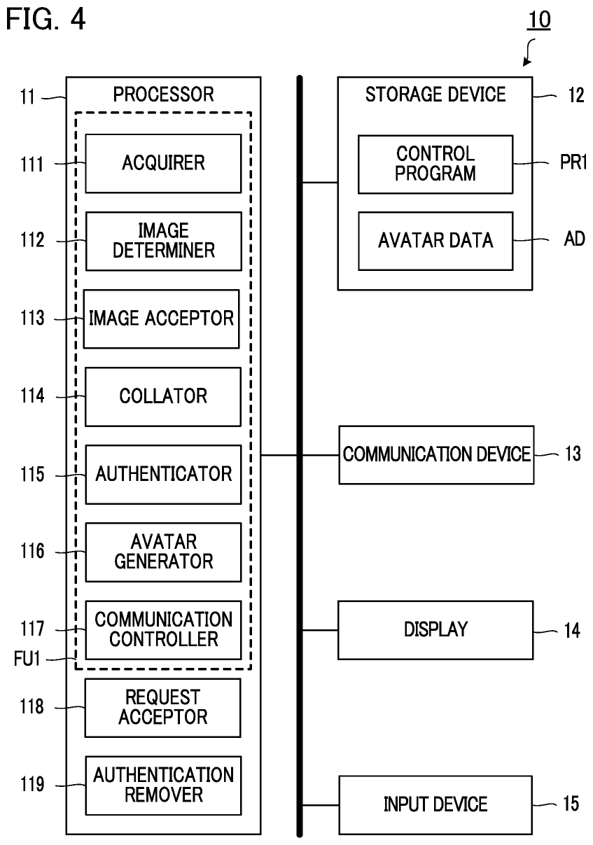

FIG. 4 is a block diagram illustrating a configuration example of the authentication apparatus 10. The authentication apparatus 10 includes a processor 11, a storage device 12, a communication device 13, a display 14, and an input device 15. Each element of the authentication apparatus 10 is connected to the others by a single bus or by multiple buses for communicating information.

The processor 11 controls the entire authentication apparatus 10. The processor 11 is constituted using, for example. a single chip or multiple chips. The processor 11 is constituted using, for example, a central processing unit (CPU) including interfaces with peripheral devices, an arithmetic unit, a register, and similar devices. It is to be noted that some or all the functions of the processor 11 may be realized by hardware such as DSP, ASIC, PLD, FPGA, or similar devices. The processor 11 executes various processes in parallel or sequentially.

The storage device 12 is a recording medium that can be read from and written to by the processor 11. The storage device 12 stores a plurality of programs including a control program PRI executed by the processor 11. Furthermore, the storage device 12 stores avatar data AD generated by an avatar generator 116, which will be described later. Furthermore, the storage device 12 stores a user image used to generate avatar data AD representing an avatar AK of a user UK. In a case in which each of a plurality of users U generates avatar data AD representing an avatar A corresponding to themselves using a method described below, it is preferred that each of the images, each piece of information, and each piece of data stored in the storage device 12 be verified, collated, created, managed, and stored in association with the account of each user U. The data stored in the storage device 12 can be read from the terminal apparatus 30.

The communication device 13 is hardware in the form of a transmitter-receiver device for communicating with other devices. The communication device 13 is also referred to as, for example, a network device, a network controller, a network card, a communication module, or as a similar device. The communication device 13 may include a connector for wired connection, and may include an interface circuit corresponding to the connector. The communication device 13 may include a wireless communication interface. Connectors and interface circuitry for wired connection include wired LAN, IEEE1394, and USB compliant devices. Examples of the wireless communication interfaces include wireless LAN and Bluetooth (registered trademark).

The display 14 is a device that displays images and text information. The display 14 displays various images under the control of the processor 11. For example, various display panels such as a liquid crystal display panel and an organic EL (Electroluminescent) display panel are suitably used as the display 14.

The input device 15 receives an operation from an administrator of the authentication apparatus 10. For example, the input device 15 includes a keyboard, a touch pad, a touch panel, or a pointing device such as a mouse. The input device 15 with a touch panel may also serve as the display 14.

The processor 11 reads and executes the control program PRI from the storage device 12. thereby functioning as an acquirer 111, an image determiner 112, an image acceptor 113, a collator 114, an authenticator 115, an avatar generator 116, a communication controller 117, a request acceptor 118, and an authentication remover 119. For simplicity of explanation, among these constituent elements, the acquirer 111, the image determiner 112, the image acceptor 113, the collator 114, the authenticator 115, the avatar generator 116, and the communication controller 117 are collectively referred to as a “functional unit FU1”.

In generating avatar data AD, the acquirer 111 acquires, from the terminal apparatus 30-K via the communication device 13, information representing a first verification image for verifying that the user UK is a user who uses the service. The “user who uses a service” is an example of a “service user”.

In removing authentication data from avatar data AD, the acquirer 111 acquires, from the terminal apparatus 30-K via the communication device 13, information representing a second verification image used for verifying the identity of the user UK.

In generating avatar data AD, the image determiner 112 determines whether a first verification image acquired by the acquirer 111 is an image obtained by capturing an image of the user of the terminal apparatus 30-K at a current time. The image determiner 112 determines whether a person in the first verification image is a person who is a target of an image capture by the image capture device 36 provided in the terminal apparatus 30-K at the current time, and not a person included in an image printed on a sheet of paper, a person included in a two-dimensional photograph displayed on a display, or a person who wears a mask on which a face of someone else is printed. More specifically, a determination method may include, for example, determining whether data representing a face, an image of which is captured as a user UK moving the face forward, backward, left, and right in front of the image capture device 36 is data representing a three-dimensional image. Furthermore, the determination method may include determining a change in a direction of light hitting the user UK, in particular, a change in a direction of light hitting the face or the body when the user UK moves the face or the body in front of the image capture device 36. Furthermore, the determination method may include determining whether there is any subtle movement of a part constituting the face and any blinking action when the user UK moves the face in front of the image capture device 36. If the user of the terminal apparatus 30-K is wearing a mask on which the face of someone else is printed, a physiological movement of a part of a face would not be detected, and thus spoofing using a mask is prevented. The “user of the terminal apparatus 30-K” is an example of a “terminal user of the terminal apparatus 30-K”.

In removing authentication data from avatar data AD, the image determiner 112 determines whether a second verification image acquired by the acquirer 111 is an image obtained by capturing an image of the user of the terminal apparatus 30-K at a current time, using the same method as that used in generating avatar data AD.

In generating avatar data AD, the image acceptor 113 receives, from the terminal apparatus 30-K, a user image used for generating the avatar data AD, which represents an avatar AK of a user UK. As described above, the user image is preferably a photograph showing only the face or the entirety of the user UK. The image acceptor 113 stores the received user image in the storage device 12.

In generating the avatar data AD, the collator 114 collates the image of the person in a first verification image with the image of the person in a user image. For example, the collator 114 compares the images of the two people based on whether the features of a face included in face data representing the face of the person in the first verification image matches the features of a face indicating the face of the person in the user image. The features of a face includes, for example, the shape of the eyebrows, eyes, nose, mouth, and the distance between the parts that make up the face.

Furthermore, in removing authentication data from avatar data AD, the collator 114 collates the image of the person in a second verification image with the image of the person in a user image, using the same method as that used in generating avatar data AD.

In a case in which a predetermined authentication condition is satisfied, the authenticator 115 verifies that avatar data AD generated by the avatar generator 116 (described later) is authentic. In a case in which the authenticator 115 verifies the authenticity of the avatar data AD, the authenticator 115 generates authentication data to be added to the avatar data AD. The “predetermined authentication condition” is, for example, that both a result of determination by the image determiner 112 and a result of collation by the collator 114 are affirmative. In a case in which the authenticator 115 verifies that the avatar data AD is authentic, the authenticator 115 may add authentication data to the avatar data AD Conversely, in a case in which the authenticator 115 cannot verify that the avatar data AD is authentic, the authenticator 115 may generate unauthenticating data indicating that the avatar data has not been authenticated, and add the unauthenticating data to the avatar data AD. Alternatively, the authenticator 115 may generate data indicating correspondence between IDs of the respective avatar data AD and authentication or lack of authentication statuses and store the data indicating the correspondence in the storage device 12. The authenticator 115 may manage the authentication data, unauthenticating data, and the data indicating the correspondence. Alternatively, an authentication information manager (not shown) may manage the authentication data, the unauthenticating data, and the data indicating the correspondence. For example, whether to add an authentication mark M to an avatar AK displayed on the display 34 may be determined based on the authentication data or the unauthenticating data associated with avatar data AD that represents the avatar AK, read from the storage device 12.

The avatar generator 116 generates avatar data AD using a user image. Specifically, the avatar generator 116 generates avatar data AD representing an avatar A that resembles a person in the user image or an avatar A that has features of the person in the user image. For example, the avatar generator 116 generates avatar data AD representing an avatar A having a face closely resembling the face of the person or an avatar A having features of the face of the person. As described above, in a case in which the authenticator 115 verifies that the avatar data AD is authentic and then authentication data is generated, the avatar generator 116 adds the authentication data to the avatar data AD, for example.

As a result, the authentication apparatus 10 can authenticate that the avatar A with an appearance that closely resembles a certain person is created by that person.

The communication controller 117 causes the communication device 13 to transmit avatar data AD generated by the avatar generator 116, to the terminal apparatus 30.

It is to be noted that the processor 11 may execute generation of avatar data AD by the avatar generator 116 after the authentication by the authenticator 115 is executed, or may execute authentication by the authenticator 115 after avatar data AD is generated by the avatar generator 116. Furthermore, the processor 11 may execute determination by the image determiner 112, collation by the collator 114, and authentication by the authenticator 115, after avatar data AD is generated by the avatar generator 116. By so doing, avatar data AD that has been previously generated and has not been authenticated can be authenticated retroactively, and the avatar data AD can be later added with information indicating that the avatar data has been authenticated. Therefore, even after the user UK generates an avatar A without authentication, it is possible to change the avatar A to one with authentication, without changing the appearance of the avatar A. More specifically, when the user UK generates an avatar AK for the first time, the user UK simply generates the avatar AK without authentication, to avoid the trouble of the authentication. Thereafter, the user UK can perform authentication when time permits, to grant authentication to the avatar AK with the same appearance as the previously generated avatar AK.

The request acceptor 118 receives, from the terminal apparatus 30, a removal request instructing removal of authentication data from avatar data AD. The request acceptor 118 is an example of an “acceptor”.

The authentication remover 119 removes authentication data from avatar data AD when a predetermined removal condition is satisfied, with the request acceptor 118 receiving a removal request as a trigger.

The “predetermined removal condition” may be, for example, a result of determination by the image determiner 112 and a result of collation by the collator 114 both being affirmative.

When the predetermined removal condition is satisfied, the authentication remover 119 may not only remove the authentication data from the avatar data AD, but also add unauthenticating data to the avatar data AD. Alternatively, in a case in which the predetermined removal condition is satisfied, the authentication remover 119 may rewrite data indicating the correspondence between an ID of the avatar data AD that specifies the avatar data AD and a corresponding authentication or lack of authentication status stored in the storage device 12.

Authentication data removed by the authentication remover 119 is not limited to authentication data generated by the authenticator 115. For example, even when the authentication apparatus 10 acquires avatar data AD, from an external terminal, to which authentication data is already added by a system other than the avatar system 1, the authentication remover 119 can remove the authentication data.

Therefore, according to the authentication apparatus 10, it is possible to add and remove authentication for the fact that the avatar A with an appearance that closely resembles a certain person is created by that person.

### 1-2: Operation of First Embodiment

### 1-2-1: Operation in Generating Avatar Data AD

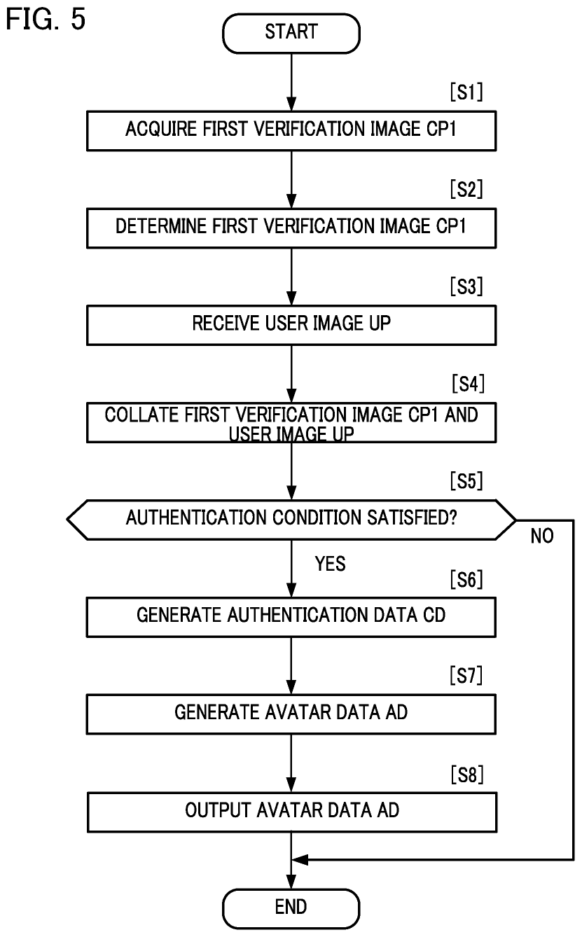

FIG. 5 is a flowchart illustrating an example operation performed when the authentication apparatus 10 generates avatar data AD. In the following, the example operation of the authentication apparatus 10 will be described with reference to FIG. 5.

At Step S1, the processor 11 functions as the acquirer 111. The processor 11 acquires, from the terminal apparatus 30-K via the communication device 13, information representing a first verification image CPI for verifying that a user UK is a user who uses the service.

At Step S2, the processor 11 functions as the image determiner 112. The processor 11 determines whether the first verification image CP1 acquired at Step S1 is an image obtained by capturing an image of the user of the terminal apparatus 30-K at a current time.

At Step S3, the processor 11 functions as the image acceptor 113. The processor 11 receives, from the terminal apparatus 30-K, a user image UP used for generation of avatar data AD representing an avatar AK of the user UK using the service.

At Step S4, the processor 11 functions as the collator 114. The processor 11 collates the image of the person in the first verification image CP1 with the image of the person in the user image UP.

In a case in which the authentication condition is satisfied at Step S5, i.e., in a case in which both the determination result at Step S2 and the collation result at Step S4 are affirmative, the processor 11 executes the processing of Step S6. On the other hand, in a case in which the authentication condition is not satisfied, i.e., in a case in which one or both of the determination result in Step S2 and the collation result in Step S4 are negative, the processor 11 ends all the processing.

At Step S6, the processor 11 functions as the authenticator 115. The processor 11 verifies that the avatar data AD to be generated is authentic. Furthermore, the processor 11 generates authentication data CD.

At Step S7, the processor 11 functions as the avatar generator 116. The processor 11 generates avatar data AD using the user image UP received at Step S3. For example, the authentication data CD generated at Step S5 is added to the avatar data AD. For example, the processor 11 stores the generated avatar data AD in the storage device 12 with the authentication data CD added thereto.

At Step S8, the processor 11 functions as the communication controller 117. The processor 11 causes the communication device 13 to transmit the avatar data AD generated at Step S7 to the terminal apparatus 30-K.

### 1-2-2: Operation in Removing Authentication Data

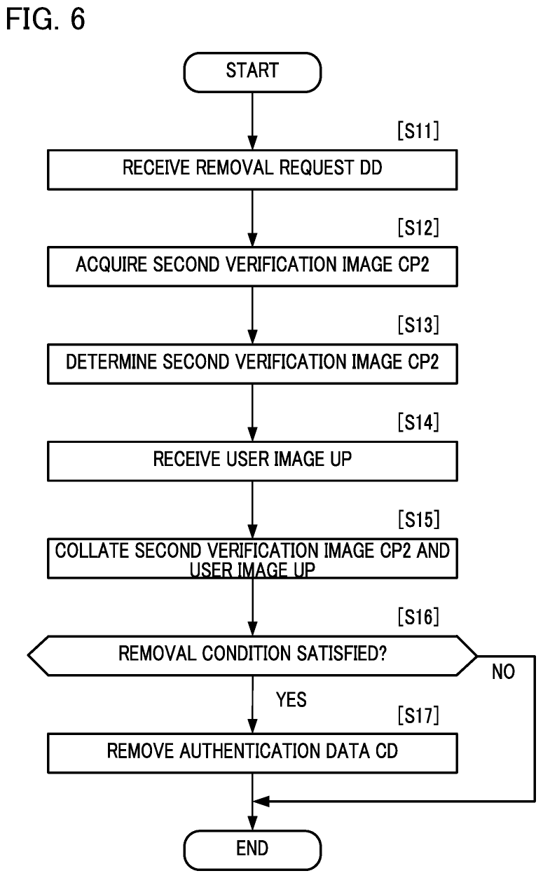

FIG. 6 is a flowchart illustrating an example operation performed when the authentication apparatus 10 removes authentication data CD. In the following, the operation example of the authentication apparatus 10 will be described with reference to FIG. 6.

At Step S11, the processor 11 functions as the request acceptor 118. The processor 11 receives, from the terminal apparatus 30-K via the communication device 13, a removal request DD requesting removal of authentication data CD.

At Step S12, the processor 11 functions as the acquirer 111. The processor 11 acquires, from the terminal apparatus 30-K via the communication device 13, information representing a second verification image CP2 for verifying that the user UK is a user who uses the service.

At Step S13, the processor 11 functions as the image determiner 112. The processor 11 determines whether the second verification image CP2 acquired at Step S12 is an image obtained by capturing an image of the user of the terminal apparatus 30-K at a current time.

At Step S14, the processor 11 functions as the image acceptor 113. The processor 11 receives, from the terminal apparatus 30-K, a user image UP used for generation of avatar data AD representing an avatar AK of the user UK who uses the service. Alternatively, when the user image UP is stored in the storage device 12, the processor 11 may receive the user image UP by reading the user image UP from the storage device 12.

At Step S15, the processor 11 functions as the collator 114. The processor 11 collates the image of the person in the second verification image CP2 with the image of the person in the user image UP.

At Step S16, in a case in which the removal condition is satisfied. that is, when both the determination result at Step S13 and the collation result at Step S15 are affirmative, the processor 11 executes the processing of Step S17. On the other hand, in a case in which the removal condition is not satisfied, that is, when one or both of the determination result at Step S13 and the collation result at Step S15 are negative, the processor 11 ends all the processing.

At Step S17, the processor 11 functions as the authentication remover 119. The processor 11 removes the authentication data CD from the avatar data AD.

### 1-3: Effects of First Embodiment

As described above, the authentication apparatus 10 according to the present embodiment includes the avatar generator 116, the authenticator 115, and the authentication remover 119. The avatar generator 116 generates avatar data AD representing an avatar AK of a user UK by using a user image UP obtained by capturing an image of the user UK who uses the service. In a case in which it is verified that the avatar data AD is authentic, the authenticator 115 generates authentication data CD. The authentication remover 119 removes the authentication data CD when the removal condition is satisfied.

Since the authentication apparatus 10 has the above-described configuration, it is possible to add and remove authentication for the avatar A having an appearance that closely resembles a certain individual and generated by that individual.

Furthermore, the authentication apparatus 10 can change the avatar AK with identity authentication, to one without identity authentication. This change can be made without changing the appearance of the avatar AK even after the avatar AK with identity authentication has been generated once. Therefore, in a case in which the user UK no longer feels the need to use the avatar AK with identity authentication, the identity authentication can be removed while maintaining the same avatar AK as previously generated.

Furthermore, as described above, the authentication apparatus 10 includes the request acceptor 118 as an acceptor, the acquirer 111, the image determiner 112, and the collator 114. The request acceptor 118 receives a removal request DD for removing the authentication data CD from the terminal apparatus 30-K. The acquirer 111 acquires from the terminal apparatus 30-K the second verification image CP2 as a verification image for verifying the identity of the user UK. The image determiner 112 verifies that the second verification image CP2 is an image obtained by capturing an image of the terminal user of the terminal apparatus 30-K at the current time. The collator 114 collates the image of the person in the second verification image CP2 with the image of the person in the user image UP. The above removal condition is that both the determination result of the image determiner 112 and the collation result of the collator 114 are affirmative.

Since the authentication apparatus 10 has the above-described configuration, the authentication data CD is removed based on a first condition of whether the second verification image CP2 is an image obtained by capturing an image of a user of the terminal apparatus 30-K, and a second condition of whether the person in the second verification image CP2 and the person in the user image UP are the same person. Therefore, the authentication apparatus 10) can prevent a third person from spoofing and removing the authentication data CD.

### 2: Second Embodiment

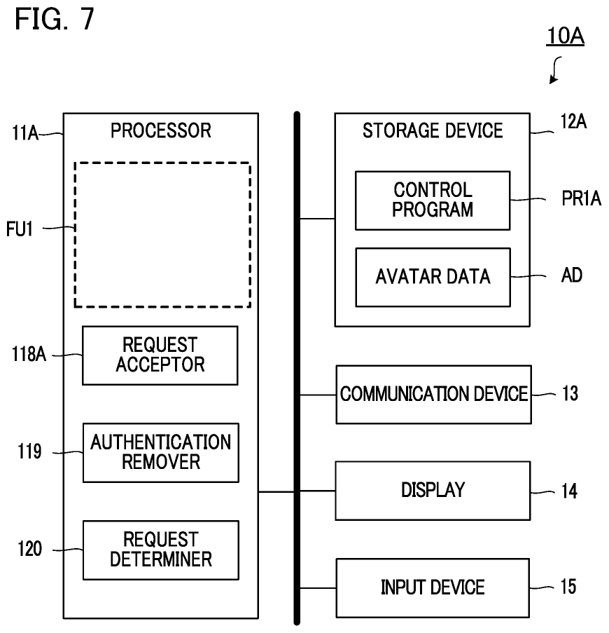

In the following, a description will be given of an avatar system IA including an authentication apparatus 10A according to a second embodiment of the present invention, with reference to FIGS. 7 to 11. To simplify the description, among the components included in the avatar system IA, the same reference numerals are used for the same components as those included in the avatar system 1, and description thereof may be omitted.

The authentication apparatus 10A according to the present embodiment forcibly generates or removes authentication data CD in a case in which a terminal apparatus 30 as an external apparatus requests generation or removal of the authentication data CD.

### 2-1: Configuration of Second Embodiment

### 2-1-1: Overall Configuration

The avatar system IA differs from the avatar system 1 in that the authentication apparatus 10A is provided in place of the authentication apparatus 10. Otherwise, the entire configuration of the avatar system IA is the same as the entire configuration of the avatar system 1 shown in FIG. 1, and thus, illustration thereof is omitted. In the following, the configuration of the authentication apparatus 10A will be mainly described.

### 2-1-2: Configuration of Authentication Apparatus

FIG. 7 is a block diagram illustrating an example configuration of the authentication apparatus 10A. The authentication apparatus 10A includes a processor 11A in place of the processor 11 and a storage device 12A in place of the storage device 12 as compared with the authentication apparatus 10. The storage device 12A stores a control program PRIA in place of the control program PRI. The processor 11A reads and executes the control program PRIA from the storage device 12A, thereby functioning as a request acceptor 118A, an authentication remover 119, and a request determiner 120 in addition to the functional unit FUI, that is, a functional unit including the acquirer 111, the image determiner 112, the image acceptor 113, the collator 114, the authenticator 115, the avatar generator 116, and the communication controller 117.

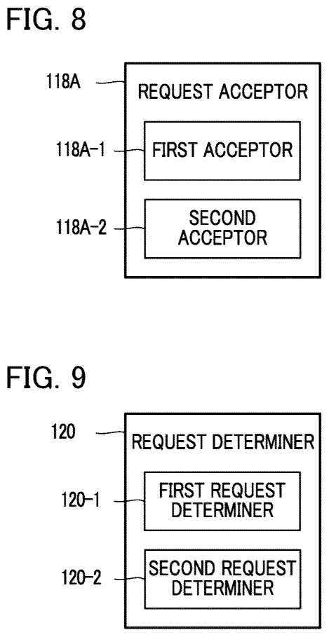

The request acceptor 118A receives a request from the terminal apparatus 30. FIG. 8 is a functional block diagram illustrating a configuration of the request acceptor 118A. The request acceptor 118A includes a first acceptor 118A-1 and a second acceptor 118A-2.

The first acceptor 118A-1 receives, from the terminal apparatus 30, a removal request DD instructing removal of the authentication data CD.

The second acceptor 118A-2 receives, from the terminal apparatus 30, a generation request instructing generation of authentication data CD.

Returning to FIG. 7, the request determiner 120 determines whether the request received by the request acceptor 118A includes a forced instruction. FIG. 9 is a functional block diagram illustrating a configuration of the request determiner 120. The request determiner 120 includes a first request determiner 120-1 and a second request determiner 120-2.

The first request determiner 120-1 determines whether a forced instruction to forcibly remove the authentication data CD without approval of the user UK is included in the removal request DD received by the first acceptor 118A-1. The “predetermined removal condition” used by the authentication remover 119 is that the determination result of the first request determiner 120-1 is affirmative. That is, the authentication remover 119 removes the authentication data CD in a case in which the determination result of the first request determiner 120-1 is affirmative.

The second request determiner 120-2 determines whether a forced instruction to forcibly generate the authentication data CD without the user UK's approval is included in the generation request received by the second acceptor 118A-2. The “predetermined authentication condition” used by the authenticator 115 is that the determination result of the second request determiner 120-2 is affirmative. That is, the authenticator 115 generates the authentication data CD when the determination result of the second request determiner 120-2 is affirmative.

### 2-2: Operation of Second Embodiment

### 2-2-1: Operation in Creating Avatar Data AD

An example operation of generating the avatar data AD by the authentication apparatus 10A is the same as the example operation of generating the avatar data AD by the authentication apparatus 10 illustrated in FIG. 5, and therefore, explanation thereof will be omitted.

### 2-2-2: Operation in Removing Authentication Data in a Normal Case

An example operation of removing the authentication data CD by the authentication apparatus 10A in a normal case is the same as the example operation of removing the authentication data CD by the authentication apparatus 10 illustrated in FIG. 6, and therefore, explanation thereof will be omitted.

### 2-2-3: Operation in Forced Removal of Authentication Data

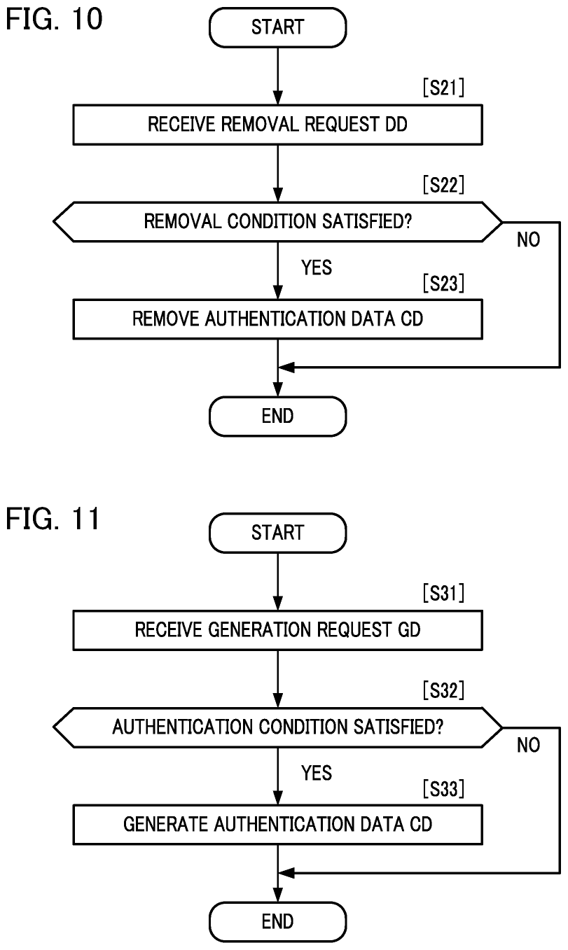

FIG. 10 is a flowchart illustrating an example operation in a case in which the authentication apparatus 10A forcibly removes authentication data CD. In the following, the example operation of the authentication apparatus 10A will be described by referring to FIG. 10.

At Step S21, the processor 11A functions as the first acceptor 118A-1. The processor ILA receives a removal request DD requesting removal of the authentication data CD from the terminal apparatus 30 via the communication device 13.

At Step S22, when the removal condition is satisfied. the processor 11A executes the processing of Step S23. On the other hand, if the removal condition is not satisfied, the processor 11A ends all the processing illustrated in FIG. 10. In this case, the processor 11A may execute the processing on and after Step S12 in the flowchart shown in FIG. 6.

More specifically, the processor 11A functions as the first request determiner 120-1. The processor 11A determines whether a forced instruction is included in the removal request DD received at Step S21. In a case in which the forced instruction is included in the removal request DD, the processor ILA executes the processing of Step S23. On the other hand, in a case in which the forced instruction is not included in the removal request DD, the processor IIA ends all the processing. In this case, the processor 11A may execute the processing on and after Step S12 in the flowchart shown in FIG. 6.

At Step S23, the processor 11A functions as the authentication remover 119. The processor 11A removes the authentication data CD from the avatar data AD.

### 2-2-4: Operation in Forced Generation of Authentication Data

FIG. 11 is a flowchart illustrating an example operation when the authentication apparatus 10A forcibly generates authentication data CD. In the following, the example operation of the authentication apparatus 10A will be described with reference to FIG. 11.

At Step S31, the processor 11A functions as the second acceptor 118A-2. The processor 11A receives a generation request GD requesting generation of authentication data CD from the terminal apparatus 30 via the communication device 13.

At Step S32, in a case in which the authentication condition is satisfied, the processor 11A executes the processing of Step S33. On the other hand, if the authentication condition is not satisfied, the processor 11A ends all the processing illustrated in FIG. 11.

Specifically, the processor 11A functions as the second request determiner 120-2. The processor 11A determines whether a forced instruction is included in the generation request GD received at Step S32. In a case in which the forced instruction is included in the generation request GD, the processor 11A executes the processing of Step S33. On the other hand, in a case in which the forced instruction is not included in the generation request GD, the processor 11A ends all the processing.

In S33, the processor 11A functions as the authenticator 115. The processor 11A generates authentication data CD.

### 2-3: Effects of Second Embodiment

According to the above explanation, the authentication apparatus 10A according to the present embodiment includes the first acceptor 118A-1 and the first request determiner 120-1. The first acceptor 118A-1 receives a removal request DD instructing removal of the authentication data CD from the terminal apparatus 30. The first request determiner 120-1 determines whether a forced instruction to forcibly remove the authentication data CD without approval from the user UK is included in the removal request DD. The above removal condition is that the determination result of the first request determiner 120-1 is affirmative.

Since the authentication apparatus 10A has the above-described configuration, the authentication data CD can be forcibly removed when the terminal apparatus 30, in the form of an external apparatus, requests removal of the authentication data CD.

Consequently, when the avatar A to which the authentication mark M is erroneously added is being used by another person, the authentication apparatus 10A can forcibly remove the authentication data CD from the avatar data AD representing the avatar A and prevent the avatar A from being used by another person. Also, in a case in which the creator of the avatar A can no longer uses the avatar A in some way, the authentication apparatus 10A can forcibly remove the authentication data CD from the avatar data AD representing the avatar A, thereby reducing the risk of another person spoofing and using the avatar A.

According to the above explanation, the authentication apparatus 10A according to the present embodiment includes the second acceptor 118A-2 and the second demand determiner 120-2. The second acceptor 118A-2 receives a generation request GD instructing to generate authentication data CD from the terminal apparatus 30. The second request determiner 120-2 determines whether there is included in the generation request GD a forced instruction to forcibly generate the authentication data CD without requiring the authentication condition. The authenticator 115 generates authentication data CD in a case in which the determination result of the second request determiner 120-2 is affirmative.

Since the authentication apparatus 10A has the above-described configuration, it is possible to forcibly generate the authentication data CD when the terminal apparatus 30, as an external apparatus, requests the generation of the authentication data CD.

The authentication apparatus 10A generates the avatar A to which the authentication mark M is not added, for example, in a case in which the user UK is not authenticated even though the user who is trying to create the avatar A is that user UK. In such cases, by the authentication apparatus 10A forcibly adding the authentication data CD to the avatar data AD corresponding to the avatar A, that user UK can use the avatar A to which the authentication mark M has been added.

### 3: Third Embodiment

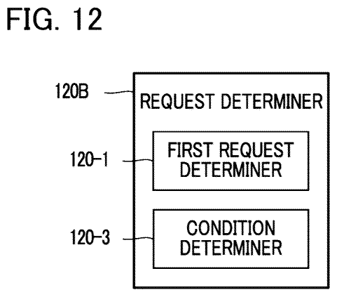

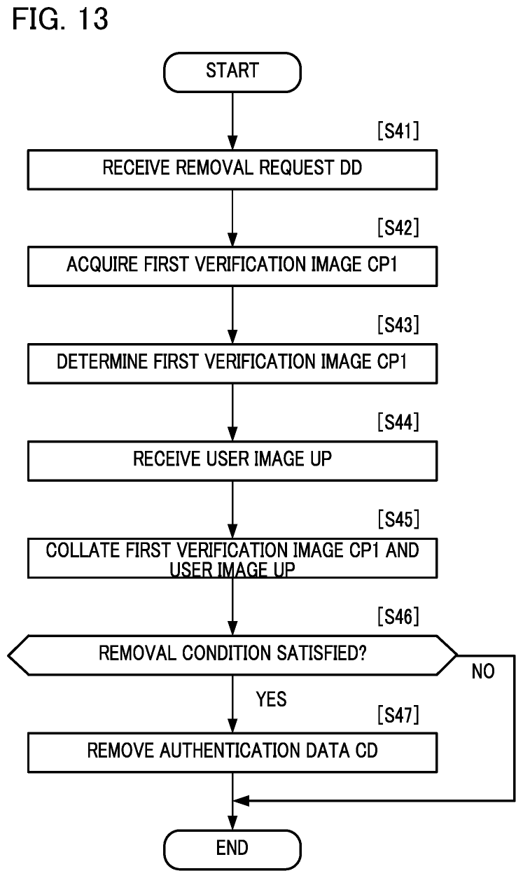

In the following, an avatar system 1B including an authentication apparatus 10B according to a third embodiment of the present invention will be described with reference to FIGS. 12 to 13. To simplify the description, among the components included in the avatar system 1B, the same reference numerals are used for the same components as those included in the avatar systems 1 and 1A, and description thereof may be omitted.

The authentication apparatus 10B according to the present embodiment stores the first verification image CPI used in generating the avatar data AD. Thereafter, for example, in a case in which it is suspected that spoofing was performed when the avatar data AD was generated, the authentication apparatus 10B determines again, by using the stored first verification image CP1, whether identity authentication was properly performed during the generation of the avatar data AD, and removes the authentication data CD when the removal condition is satisfied.

### 3-1: Configuration of Third Embodiment

### 3-1-1: Overall Configuration

The avatar system 1B differs from the avatar system 1 in that the authentication apparatus 10B is provided in place of the authentication apparatus 10. Otherwise, the entire configuration of the avatar system 1B is the same as the entire configuration of the avatar system 1 shown in FIG. 1, and thus, the illustration thereof is omitted. In the following, the configuration of the authentication apparatus 10B will be mainly described.

### 3-1-2: Configuration of Authentication Apparatus

The authentication apparatus 10B includes a processor 11B in place of the processor 11, and a storage device 12B in place of the storage device 12, as compared with the authentication apparatus 10. The storage device 12B stores a control program PR1B in place of the control program PRI. The processor 11B reads and executes the control program PR1B from the storage device 12B, thereby functioning as a request acceptor 118, an authentication remover 119, and a request determiner 120B in addition to a functional unit having an acquirer 111B, an image determiner 112B, an image acceptor 113B. a collator 114B, an authenticator 115B, an avatar generator 116, and a communication controller 117, as a functional unit FU1B. Otherwise, the overall configuration of the authentication apparatus 10B is the same as the configuration of the authentication apparatus 10A according to the second embodiment shown in FIGS. 7 and 8, and thus, illustration thereof is omitted.

Like the acquirer 111, the acquirer 111B acquires the first verification image CPI from the terminal apparatus 30-K when the avatar data AD is generated. Furthermore, the acquirer 111B stores the acquired first verification image CPI in the storage device 12B. In the present embodiment, the first verification image CPI is an example of a “verification image”. The terminal apparatus 30-K is an example of the “external apparatus”.

Like the image determiner 112, in generating avatar data AD, the image determiner 112B determines whether the first verification image CPI acquired by the acquirer 111B is an image obtained by capturing an image of the user of the terminal apparatus 30-K at a current time.

In removing the authentication data CD from the avatar data AD, the image determiner 112B performs the above determination using the first verification image CP1 read from the storage device 12B. Specifically, the image determiner 112B determines whether the first verification image CPI read from the storage device 12B is an image that was obtained by capturing an image of the user of the terminal apparatus 30-K when the avatar data AD was generated.

Like the image acceptor 113, in generating the avatar data AD, the image acceptor 113B receives from the terminal apparatus 30-K a user image UP to be used for generating avatar data AD representing an avatar AK of the user UK. The image acceptor 113B stores the received user image UP in the storage device 12B.

The image acceptor 113B reads the user image UP from the storage device 12B in removing the authentication data CD from the avatar data AD. The image acceptor 113B receives the read user image UP.

Like the collator 114, in generating the avatar data AD, the collator 114B collates the image of the person in the first verification image CPI with the image of the person in the user image UP.

In removing the authentication data CD from the avatar data AD, the collator 114B executes the collation using the first verification image CPI and the user image UP read from the storage device 12B. Specifically, the collator 114B collates the image of the person in the first verification image CPI with the image of the person in the user image UP.

Like the authenticator 115, in generating the avatar data AD, the authenticator 115B authenticates that the avatar data AD is authentic by using the first verification image CPI acquired by the acquirer 111B. Specifically, the authenticator 115B determines whether both the determination result based on a first determination condition by the image determiner 112B and the collation result based on a second determination condition by the collator 114B are affirmative. Specifically, the first determination condition is a determination condition used in determining whether it is affirmative that the first verification image CPI acquired by the acquirer 111B is an image obtained by capturing an image of the user of the terminal apparatus 30-K at the time of generating the avatar data AD. The second determination condition is a determination condition used for determining whether the person in the first verification image CPI and the person in the user image UP received by the image acceptor 113 are the same person. The “predetermined authentication condition” described above means that both the determination result based on the first determination condition and the collation result based on the second determination condition are affirmative.

FIG. 12 is a functional block diagram illustrating a configuration of the request determiner 120B. As illustrated in FIG. 12, the request determiner 120B includes a condition determiner 120-3 in place of the second request determiner 120-2 as compared with the request determiner 120 according to the second embodiment.

In removing the authentication data CD from the avatar data AD, the condition determiner 120-3 performs a determination based on the first determination condition, which is the same as the first determination condition used by the authenticator 115B. In addition, the condition determiner 120-3 performs determination based on the second determination condition, which is the same as the second determination condition used by the authenticator 115B. Specifically, the first determination condition is a determination condition used for determining whether the first verification image CPI read from the storage device 12B is an image obtained by capturing an image of the user of the terminal apparatus 30-K as an external apparatus. The second determination condition is a determination condition for determining whether the person in the first verification image CPI read from the storage device 12B and the person in the user image UP read from the storage device 12B are the same person. In a case in which both determination based on the first determination condition and determination based on the second determination condition are affirmative, the determination result by the condition determiner 120-3 is affirmative. On the other hand, when one or both of the determination based on the first determination condition and the determination based on the second determination condition are negative, the determination result by the condition determiner 120-3 is negative.

The strictness of the determination condition differs between the first determination condition used by the authenticator 115B and the first determination condition used by the condition determiner 120-3. For example, in the authentication by the authenticator 115B, in verifying whether it is affirmative that the first verification image CP1 is an image obtained by capturing an image of the user of the terminal apparatus 30-K as the external apparatus, the image determiner 112B only verifies that data representing a face, an image of which is captured by moving the face forward, backward, left, and right by the user UK. in front of the image capture device 36, is data representing a three-dimensional image. On the other hand, in the determination by the condition determiner 120-3, the image determiner 112B determines, in addition to verifying that the data representing the face is the data representing the three-dimensional image, the subtle movements of the parts constituting the face and blinking actions.

The strictness of the determination condition differs between the second determination condition used by the authenticator 115B and the second determination condition used by the condition determiner 120-3. For example, the collator 114B determines through collation whether the image of the person in the first verification image CPI and the image of the person in the user image UP are the same, both in the authentication by the authenticator 115B and the determination by the condition determiner 120-3. However, if the similarity of two people, as determined by the condition determiner 120-3, is lower than the similarity determined during the authentication by the authenticator 115B, the collator 114B does not conclude that the two people are the same.

The “predetermined removal condition” used by the authentication remover 119 is that the determination result by the first request determiner 120-1 is affirmative and the determination result by the condition determiner 120-3 is negative. That is, the authentication remover 119 removes the authentication data CD when the determination result by the first request determiner 120-1 is affirmative and the determination result by the condition determiner 120-3 is negative.

### 3-2: Operation of Third Embodiment

### 3-2-1: Operation in Generating Avatar Data AD

An example operation performed by the authentication apparatus 10B to generate avatar data AD is generally the same as that performed by the authentication apparatus 10 to generate the avatar data AD illustrated in FIG. 5, and thus, an illustration of an example operation of the authentication apparatus 10B is omitted. In the following, from among the example operation performed by the authentication apparatus 10B to generate the avatar data AD, a description will be given of those processes that differ from the example operation to generate the avatar data AD by the authentication apparatus 10.

At Step S1, a processor 11B functions as the acquirer 111B. The processor 11 acquires, from the terminal apparatus 30-K via the communication device 13. information representing the first verification image CPI for verifying that the user UK is the user who uses the service. Furthermore, the processor 11B stores the acquired first verification image CP1 in the storage device 12A. The terminal apparatus 30-K is an example of an “external apparatus”.

At Step S6, the processor 11B functions as the authenticator 115B. The processor 11B uses the first verification image CPI to verify that the avatar data AD to be generated is authentic. Specifically, the “authentication condition” of Step S5 includes, in generating the avatar data AD, that the image determiner 112B has determined that the first verification image CPI acquired by the acquirer 111B is an image obtained by capturing an image of the user of the terminal apparatus 30-K at a current time. At Step S6, the processor IIB verifies that the avatar data AD to be generated is authentic based on the authentication condition using the first verification image CPI, which is the determination condition at Step S5. Furthermore, the processor 11B generates authentication data CD.

### 3-2-2: Operation in Removing Authentication Data

FIG. 13 is a flowchart illustrating an example operation when the authentication apparatus 10B removes the authentication data CD. In the following, the example operation of the authentication apparatus 10B will be described by referring to FIG. 13.

At Step S41, the processor 11B functions as the request acceptor 118. The processor 11B receives, via the communication device 13, a removal request DD requesting removal of the authentication data CD from a terminal apparatus 30 differing from the terminal apparatus 30-K that was used to generate the avatar data AD.

For example, in a case in which a user U, who is different from the user UK, is spoofing the user UK and uses the terminal apparatus 30-K to generate the avatar data AD, a case may be assumed in which the user UK themselves makes a request to remove the authentication data CD from the terminal apparatus 30-K. In such a case, the processor 11A may receive a removal request DD requesting removal of the authentication data CD from the terminal apparatus 30-K.

At Step S42, the processor 11B functions as the acquirer 111B. The processor 11B obtains, from the storage device 12B, the information representing the first verification image CPI for verifying that the user UK is the user who uses the service.

At Step S43, the processor 11B functions as the image determiner 112B. The processor 11B determines whether the first verification image CPI acquired at Step S42 is an image obtained by capturing an image of the user of the terminal apparatus 30-K at the time of generating the avatar data AD.

At Step S44, the processor 11B functions as the image acceptor 113B. The processor 11A receives, from the storage device 12B, the user image UP that was used for generating avatar data AD representing the avatar AK of the user UK using the service.

At Step S45, the processor 11A functions as the collator 114B. The processor 11B collates the image of the person in the first verification image CPI with the image of the person in the user image UP.

At Step S46, when the removal condition is satisfied, that is, when the determination result when the processor 11B functions as the first request determiner 120-1 is affirmative, and when the determination result when the processor 11B functions as the condition determiner 120-3 is negative, the processor 11B executes the processing of Step S47. On the other hand, if the removal condition is not satisfied, the processor 11B ends all the processing.

At Step S47, the processor 11B functions as the authentication remover 119. The processor 11B removes the authentication data CD from the avatar data AD.

As described above. in the authentication apparatus 10B according to the present embodiment, in generating avatar data AD, a user image UP is acquired from the terminal apparatus 30-K (the external apparatus) together with a first verification image CPI (the verification image). The user image UP is stored in the storage device 12B together with the first verification image CPI. In a case in which the first verification image CPI is an image obtained by capturing an image of the user of the terminal apparatus 30-K and the person in the first verification image CP1 and the person in the user image UP are the same person, the authenticator 115B verifies that the avatar data AD is authentic. The authentication apparatus 10B includes the condition determiner 120-3. The condition determiner 120-3 determines whether the first verification image CPI read from the storage device 12B is an image obtained by capturing an image of the user of the terminal apparatus 30-K. Furthermore, the condition determiner 120-3 determines whether the person in the first verification image CPI read from the storage device 12B and the person in the user image UP read from the storage device 12B are the same person. The above removal condition is that the determination result of the first request determiner 120-1 is affirmative and one or both of the two determination results by the condition determiner 120-3 are negative.

Since the authentication apparatus 10B has the above-described configuration, for example, when it is suspected that spoofing was performed when the avatar data AD was generated, the authentication apparatus 10B determines again, using the stored first verification image CPI, whether identity authentication was properly performed when the avatar data AD was generated, and when the removal condition is satisfied, the authentication data CD can be removed.

### 4: Modifications

The present disclosure is not limited to the embodiments illustrated above. For example, two or more forms optionally selected from the above embodiments may be combined. In addition, the forms of specific modifications are illustrated below. Two or more forms optionally selected from the following examples may be combined.

### 4-1: Modification 1

The avatar system 1 according to the first embodiment may verify the identity of a user, by using face information of the user UK who uses the avatar data AD, for the purpose of verifying the identity of the user when the avatar data AD is used.

As an example, the authentication apparatus 10 acquires account information of the user UK from the terminal apparatus 30-K and stores the account information in the storage device 12 during normal operation. The account information may include one or more of a user UK account ID, a user UK telephone number, a user UK mail address, biometric information such as a user UK fingerprint, a photograph on the driver's license of the user UK, and a user UK facial photograph database.

In allowing the user to use the avatar data AD after authenticating that the user UK is an authentic user, the authentication apparatus 10 acquires a verification image such as a facial photograph of the user UK from, for example, a photograph on a driver's license of the user UK and a database of facial photographs of the user UK included in the account information. Then, the authentication apparatus 10 confirms whether a verification image such as a facial photograph of the user UK corresponds to an image obtained by capturing an image of a user of the terminal apparatus 30-K at a current time. In a case in which a result of the confirmation is affirmative, the authentication apparatus 10 verifies that the user UK is an authentic user and allows the use of the avatar data AD.

As another example, the authentication apparatus 10 embeds, in the avatar data AD, user image data representing a user image UP such as a facial photograph of a user UK as a digital watermark. In allowing the user to use the avatar data AD after authenticating that the user UK is an authentic user, the authentication apparatus 10 extracts the user image data from the avatar data AD. Furthermore, the authentication apparatus 10 collates the image of the person in the user image UP represented by the user image data with the image of the person in an image obtained by capturing an image of the user of the terminal apparatus 30-K. When a result of the collation is affirmative, the authentication apparatus 10 authenticates that the user UK is an authentic user and allows the use of the avatar data AD.

When the authentication apparatus 10 according to the first embodiment removes the authentication data CD from the avatar data AD, the authentication apparatus 10) may remove the account information of the user UK from the storage device 12. Alternatively, the authentication apparatus 10 may remove the user image data embedded in the avatar data AD. The same applies to the second embodiment and the third embodiment.

### 5: Other Matters

(1) In the foregoing embodiments, the authentication apparatuses 10 to 10B and the terminal apparatus 30 are described as examples. The storage devices provided in the authentication apparatuses 10 to 10B and the terminal apparatus 30 are a flexible disk, a magneto-optical disk (for example, a compact disc, a digital versatile disc, or a Blu-ray (registered trademark) disc), a smart card, a flash memory device (for example, a card, a stick, or a key drive), a compact disc-ROM (CD-ROM), a register, a removable disk, a hard disk, a floppy (registered trademark) disk, a magnetic strip, a database, a server, or another appropriate storage medium. A program executed by the external apparatus may be transmitted from a network via an electric communication line. The programs may be transmitted from the communication network NET via the electric communication line.

(2) In the foregoing embodiments, the information, signal, or the like may be expressed by using any of various different techniques. For example, data, an order, a command, information, a signal, a bit, a symbol, a chip, or the like that can be referred to throughout the description above may be expressed by using a voltage, a current, electromagnetic waves, a magnetic field or a magnetic particle, an optical field or a photon, or any combination thereof.

(3) In the foregoing embodiments, information or the like that has been input or output may be stored in a specified place (for example, a memory), or may be managed by using a management table. The information or the like that has been input or output can undergo overwriting, updating, or postscripting. The information or the like that has been output may be deleted. The information or the like that has been input may be transmitted to another apparatus.

(4) In the foregoing embodiments, determination may be performed on the basis of a value (0 or 1) expressed by using one bit, may be performed on the basis of a Boolean value (true or false), or may be performed on the basis of a comparison between numerical values (for example, a comparison with a predetermined value).

(5) In a processing procedure, a sequence, a flowchart, or the like that has been described as an example in the embodiments described above, the order may be changed as long as there is no conflict. For example, in the method described in the present disclosure, various step elements have been provided by using an illustrative order, and the specified order that has been provided is not restrictive.

(6) The respective functions illustrated in FIGS. 1, 3, 4, 7 to 9, and 12 are implemented by any combination of at least one of hardware and software. A method for implementing respective function blocks is not particularly limited. Stated another way, the respective function blocks may be implemented by using a single physically or logically coupled device, or may be implemented by directly or indirectly (for example, in a wired manner, in a wireless manner, or the like) connecting two or more devices that are physically or logically separated, and using these multiple devices. The function blocks may be implemented by a combination of the single device described above or the plural devices described above and software.

(7) The foregoing programs as an example in the embodiments described above are to be broadly construed as meaning an order, an order set, a code, a code segment, a program code, a program, a sub-program, a software module, an application, a software application, a software package, a routine, a sub-routine, an object, an executable file, an execution thread, a procedure, a function, or the like, regardless of whether the programs are referred to as software, firmware, middleware, a microcode, a hardware description language, or another term.

Software, an order, information, or the like may be transmitted or received via a transmission medium. For example, when software is transmitted from a website, a server, or another remote source by using at least one of a wired technique (a coaxial cable, an optical fiber cable, a twisted-pair wire, a digital subscriber line (DSL), or the like) or a wireless technique (infrared rays, microwaves, or the like), at least one of these wired and wireless techniques falls under the definition of the transmission medium.

(8) In each of the embodiments described above, the terms “system” and “network” are compatibly used.

(9) The information, the parameter, or the like that has been described in the present disclosure may be expressed by using an absolute value, may be expressed by using a value relative to a predetermined value, or may be expressed by using other corresponding information.

(10) In the foregoing embodiments, the authentication apparatuses 10 to 10B and the terminal apparatus 30 are a mobile station (MS) in some cases. In some cases, the mobile station is referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms by those skilled in the art. In the present disclosure, the terms “mobile station”, “user terminal”, “user equipment (UE)”, “terminal”, and the like can be compatibly used.

(11) In the foregoing embodiments, the terms “connected”, and “coupled”, or all transformations thereof mean all types of direct or indirect connection or coupling of two or more elements, and can include that one or more intermediate elements exist between two elements that are “connected” or “coupled” to each other. Coupling or connection of elements may be physical coupling or connection, logical coupling or connection, or a combination thereof. For example, “connection” may be replaced with “access”. In the case of use in the present disclosure, it can be considered that two elements are “connected” or “coupled” to each other by using at least one of one or more electric wires, cables, and printed electrical connection, and by using electromagnetic energy or the like having wavelengths of, as some non-limiting and non-comprehensive examples, a wireless frequency range, a microwave region, and a light (both visible and invisible) region.

(12) In the foregoing embodiments, the description “on the basis of” does not mean “solely on the basis of” unless otherwise specified. In other words, the description “on the basis of” means both “solely on the basis of” and “at least on the basis of”.

(13) The term “determining” used in the present disclosure includes a variety of operations in some cases. The “determining” can include, for example, that “judging”, “calculating”, “computing”, “processing”, “deriving”, “investigating”, “looking up, search, or inquiry” (for example, looking up, search, or inquiry of a table, a database, or another data structure), ascertaining is considered as “determining”. The term “determining” can include, for example, that “receiving” (for example, receiving information), “transmitting” (for example, transmitting information), “input”, “output”, or “accessing” (for example, accessing data in a memory) is considered as “determining”. The term “determining” can include that “resolving”, “selecting”, “choosing”, “establishing”, “comparing”, or the like is considered as “determining”. Stated another way, “determining” can include that any kind of operation is considered as “determining”. The term “determining” may be replaced with “assuming”, “expecting”, “considering”, or the like.

(14) In the embodiments described above, in a case in which “include”, “including”, and modifications thereof are used, these terms are intended to be comprehensive in substantially the same manner as the term “comprising”. The term “or” used in the present disclosure is not intended to be the exclusive OR.

(15) In the present disclosure, for example, in a case in which an article, such as a, an, or the, is added, the present disclosure may include that nouns that follow these articles are plural.

(16) In the present disclosure, the description “A and B are different” may mean “A and B are different from each other”. The description may mean “each of A and B is different from C”. The terms “separated”, “coupled”, and the like may be construed in substantially the same manner as “different”.

(17) Respective aspects and embodiments described in the present disclosure may be used individually, may be combined and used, or may be switched and used according to execution. A report of predetermined information (for example, a report of “X”) is not limited to a report that is explicitly made, and may be implicitly made (for example, without making a report of the predetermined information).

The present disclosure has been described in detail above, but it would be obvious to those skilled in the art that the present disclosure is not limited to the embodiments described in the present disclosure. The present disclosure can be implemented as alterations and modifications without departing from the spirit and scope of the present disclosure specified by the description of the claims. Accordingly, the description of the present disclosure has been provided for exemplary and explanatory purposes and is not restrictive of the present disclosure.

### DESCRIPTION OF REFERENCE SIGNS

1 to 1B . . . avatar system, 10 to 10B . . . authentication apparatus, 11 to 11B . . . processor, 12 to 12B . . . storage device, 13 . . . communication device, 14 . . . display, 15 . . . input device, 30 . . . terminal apparatus, 31 . . . processor, 32 . . . storage device, 33 . . . communication device, 34 . . . display, 35 . . . input device, 36 . . . image capture device, 111,111B . . . acquirer, 112,112B . . . image determiner, 113,113B . . . image acceptor, 114,114B . . . collator, 115,115B . . . authenticator, 116 . . . avatar generator, 117 . . . communication controller, 118, 118A . . . request acceptor, 118A-1 . . . first acceptor, 118A-2 . . . second acceptor, 119 . . . authentication remover, 120, 120B . . . request determiner, 120-1 . . . first request determiner, 120-2 . . . second request determiner, 120-3 . . . condition determiner, 311 . . . acquirer, 312 . . . display controller, 313 . . . communication controller, FU1,FU1B . . . functional unit, CP1 . . . first verification image, CP2 . . . second verification image, PR1,PR1A,PR1B,PR3 . . . control program.

1. An authentication apparatus of avatar data, the authentication apparatus comprising:
an avatar generator configured to generate avatar data representative of an avatar of a service user who uses a service relating to avatars, the avatar data being generated using a user image obtained by capturing an image of the service user;
an authenticator configured to generate authentication data in a case in which the avatar data is verified as being authentic; and
an authentication data remover configured to remove the authentication data based on a removal condition being satisfied.

2. The authentication apparatus according to claim 1, further comprising:
an acceptor configured to receive from a terminal apparatus a removal request instructing removal of the authentication data;
an acquirer configured to acquire from the terminal apparatus a verification image to be used to verify identify of the service user;
an image determiner configured to determine whether the verification image is an image obtained by capturing an image of a terminal user of the terminal apparatus at a current time; and
a collator configured to collate an image of a person in the verification image with an image of a person in the user image,
wherein the removal condition is that both a result of determination by the image determiner and a result of collation by the collator are affirmative.

3. The authentication apparatus according to claim 1, further comprising:
a first acceptor configured to receive from a terminal apparatus a removal request instructing removal of the authentication data; and
a first request determiner configured to determine whether the removal request includes an instruction for forced removal of the authentication data without permission from the user,
wherein the removal condition is at least a result of determination by the first request determiner being affirmative.

4. The authentication apparatus according to claim 3, further comprising:
a second acceptor configured to receive a generation request instructing generation of the authentication data from the terminal apparatus; and
a second request determiner configured to determine whether the generation request includes an instruction for forced generation of the authentication data without permission from the user,
wherein the authenticator is configured to generate the authentication data in a case in which a result of determination by the second request determiner is affirmative.

5. The authentication apparatus according to claim 3, wherein:
the user image is acquired when the avatar data is generated, the user image being acquired from an external apparatus together with a verification image,
the user image is stored in a storage device together with the verification image,
the authenticator is configured to verify that the avatar data is authentic in a case in which the verification image is an image obtained by capturing an image of a user of the external apparatus and a person in the verification image and a person in the user image are the same person,
the authentication apparatus further comprises a condition determiner configured to determine whether the verification image read from the storage device is an image obtained by capturing an image of the user of the external apparatus and determine whether the person in the verification image read from the storage device and the person in the user image read from the storage device are the same person,
one or both of a first determination condition and a second determination condition differ from each other between a time of authentication of the avatar data by the authenticator and a time of determination by the condition determiner, the first determination condition being used in determining whether the verification image is an image obtained by capturing an image of the user of the external apparatus and the second determination condition being used in determining whether the person in the verification image is the same as the person in the user image, and
the removal condition is that a result of determination by the first request determiner is affirmative and one or both of two determination results by the condition determiner are negative.
